(19) United States
(12) Patent Application Publication
(10) Pub. No.: US 2007/0195198 A1
(43) Pub. Date: Aug. 23, 2007

(54) Method and apparatus for eliminating optical sensor flickering in video gaming systems

(76) Inventors: Soo Sean Lim, Ipoh (MY); Lye Hock Bernard Chan, Bayan Lepas (MY); Tong Sen Liew, Taiping (MY)

Correspondence Address: Kathy Manke;Avago Technologies Limited, 4380 Ziegler Road, Fort Collins, CO, 80525, US

(21) Appl. No.: 11/358,163

(22) Filed: Feb. 21, 2006

(51) Int. Cl. H04N 5/00

(52) U.S. Cl. 348/607

(57) ABSTRACT

Synchronizing a shutter control signal of an optical sensor device of a video gaming system with a horizontal retrace signal generated by a game console of the system such that the frame rate of the optical sensor device is synchronized to the horizontal retrace signal. Synchronizing the frame rate to the horizontal retrace signal eliminates or reduces the occurrence of random stripes in the images captured by the optical sensor device, commonly known as flickering.

### BACKGROUND OF THE INVENTION

Video gaming systems allow users to play games through interaction with an input device as images are displayed on a display device, such as a television screen or computer monitor. A problem known as flickering exists in video gaming systems, and is caused by pixels being turned off while the optical sensor shutter is open while frames are refreshed.

FIG. 1 illustrates a block diagram of a video gaming system 2 having a display device 3, a game console 4 and an input device 5. The input device 5 has an optical sensor 6, which is usually an array of photodetector elements. As video images are displayed on the display device 3, a user moves the input device 5, which may be a mouse, a joystick, etc. The input device 5 is used as a pointing device to navigate a pointing icon or the like on the display device 3.

The optical sensor 6 of the input device 5 receives light from the display device 3. The optical sensor 6 converts the optical signals it receives into electrical signals, which are then processed by the input device 5 to obtain the pointed-to location on the screen of the display device 3. The electrical signals representing the pointed-to location are then output to the game console 4. As the input device 5 is moved, the light received by the array elements of the sensor 6, which are commonly referred to as pixels, varies in intensity. These optical variations cause the electrical signals produced by the optical sensor 6 to vary. Processing circuitry (not shown) of the game console 4 processes the electrical signals received from the input device 5 and outputs corresponding electrical signals to processing circuitry (not shown) of the display device 3, which causes the pointed -to location to be varied.

The display device 3 “paints” video frames on the display device 3 by setting the intensity values of the pixels that make up the screen of the display device 3. The pixel intensity values are set in accordance with an addressing process that addresses pixels in a sequence that moves from left to right and from top to bottom, turning on one pixel at a time. The display device 3 is typically a cathode ray tube (CRT) and the pixel intensity values are set via application of an electron beam that scans the CRT in a sequence from left to right and from top to bottom.

After the rightmost pixel in a row has been addressed, a horizontal retrace signal occurs, which causes the electron beam to move from the rightmost pixel in a row to the leftmost pixel of the next row down in the display screen. A delay period occurs during this repositioning of the electron beam, the duration of which is commonly referred to as the horizontal retrace delay, or the horizontal blanking interval (HBI). After the rightmost pixel of the bottom row in the display screen has been addressed, the electron beam moves from the rightmost pixel in the bottom row in the display screen to the leftmost pixel in the top row of the display screen. A vertical retrace signal causes the electron beam to move from the rightmost pixel in the bottom row in the display screen to the leftmost pixel in the top row of the display screen.

The game console 4 outputs a composite video signal that is made up of three different types of information, namely, pixel intensity information, horizontal retrace information and vertical retrace information. The display device 3 uses the information contained in the composite video signal to set pixel values and to control the timing at which pixel values are set.

The optical sensor 6 captures each frame with randomly occurring black stripes that are caused by dark rows of dark pixels outside of the shutter of the optical sensor 6. These randomly occurring black stripes, are commonly referred to as “flickering”. This flickering degrades the images captured by the sensor 6, and thus degrades the performance of the sensor. It would be desirable to provide a way to eliminate or reduce flickering in video gaming systems.

### SUMMARY OF THE INVENTION

The invention provides a method and an apparatus for eliminating or reducing flickering in a video gaming system. The apparatus comprises a game console and an input device having an optical sensor. The game console generates a horizontal retrace signal, which is received by the input device. The optical sensor device is configured to commence capturing of an image of at least a portion of a display screen upon receiving an asserted shutter control signal. The shutter control signal is synchronized with the horizontal retrace signal such that a frame rate of the optical sensor device is synchronized to the horizontal retrace signal. By synchronizing the horizontal retrace signal with the frame rate, the occurrence of random stripes in the images captured by the optical sensor is reduced or eliminated.

The method comprises generating a horizontal retrace signal in a game console, receiving the horizontal retrace signal from the game console in an input device, and synchronizing the shutter control signal of an optical sensor of the input device with the horizontal retrace signal.

The invention also provides a computer program for reducing or eliminating flickering in a video gaming system. The program includes instructions for receiving the horizontal retrace signal from the game console in an input device, and instructions for synchronizing the shutter control signal of an optical sensor of the input device with the horizontal retrace signal.

### BRIEF DESCRIPTION OF THE DRAWINGS

FIG. 1 illustrates a block diagram of a known gaming system.

FIG. 2 illustrates a block diagram of the gaming system of the invention in accordance with an exemplary embodiment.

FIG. 3 illustrates a timing diagram that demonstrates the synchronization of the horizontal trace signal with the frame rate in accordance with the invention.

FIG. 4 illustrates a block diagram that represents the portion of the input device 30 that transforms the horizontal retrace signal into a shutter control signal.

### DETAILED DESCRIPTION OF THE PREFERRED EMBODIMENT

In accordance with the invention, the optical sensor of the input device has a shutter signal that is synchronized to the horizontal retrace signal such that the aforementioned flickering problem is reduced or eliminated.

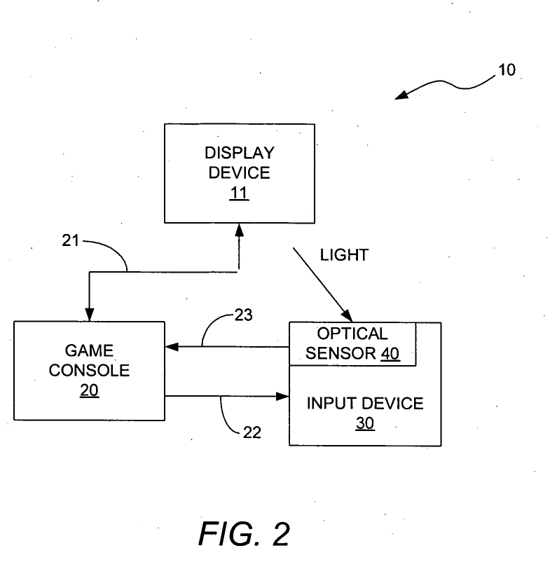

FIG. 2 illustrates a block diagram of a video gaming system 10 in accordance with an exemplary embodiment of the invention. The display device 11 may be any type of display device, including, for example, a television, a computer display monitor, a telephone display device, etc. The display device may incorporate any type of display technology, including, for example, CRT technology, liquid crystal display (LCD) technology, etc. The display device 11 is in communication with a game console 20 via a gaming interface 21, which may be, for example, a peripheral device interface such as a Universal Serial Bus (USB) interface. Data is communicated from the game console 20 to the display monitor 11 and from the display monitor 11 to the game console 20 via the interface 21.

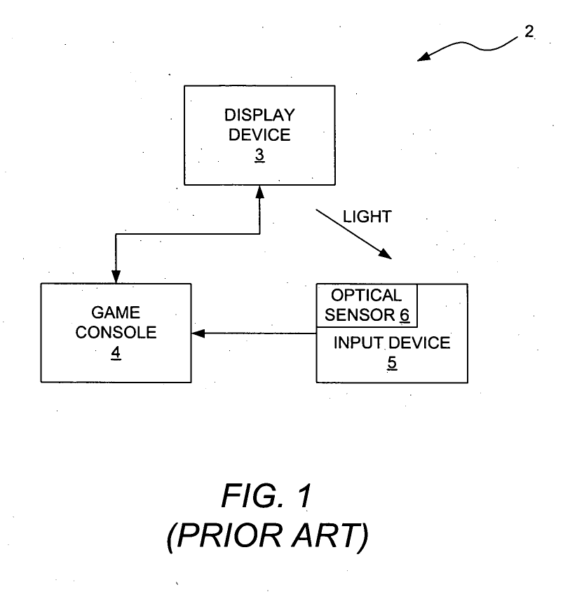

An input device 30 of the gaming system 10 performs the functions described above with reference to the input device 5 shown in FIG. 1. However, in addition, the input device 30 generates the shutter signal that is synchronized to the horizontal retrace signal. The shutter signal controls when the optical sensor 40 captures a frame of image data. The arrow 22 from the game console 20 to the input device 30 represents the horizontal retrace signal output from the game console 20 and received by the input device 30. The arrow 23 from the input device 30 to the game console 20 represents electrical signals that represent the information describing the location pointed to on the screen of the display device 11 being output by the input device 30 and received by the game console 20. The game console 20 includes processing circuitry (not shown) that processes the information describing the pointed-to location on the screen. The game console 20 causes the next image frame and the pointer to be displayed on the screen of the display device 11.

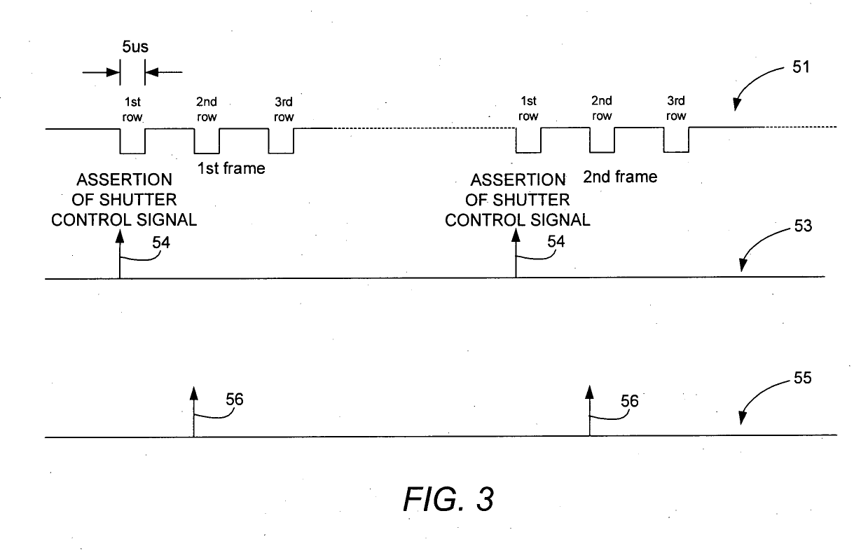

FIG. 3 illustrates a timing diagram that demonstrates the synchronization of the horizontal trace signal with the frame rate. The horizontal retrace signal 51 is high when image data is being written to a row of pixels in the screen of the display device 11. The horizontal retrace signal 51 is low during the HBI while the beam moves from the right side of the row to the left side of the next row down. The HBI may have duration of, for example, 5 microseconds. Traces 53 and 55 correspond to the timing associated with the capture of image frames by the sensor 40 as controlled by the shutter control signal. The arrows 54 and 56 in traces 53 and 55, respectively, represent assertion of the shutter control signal, which causes the sensor 40 to capture an image frame. Trace 53 represents an exemplary case in which the sensor 40 begins capturing an image frame whenever the horizontal retrace signal corresponding to the first row in the screen of the display device 11 transitions from high to low, i.e., on the falling edge. Trace 55 represents an exemplary case in which the sensor 40 begins capturing an image frame whenever the horizontal retrace signal corresponding to the second row in the screen of the display device 11 transitions from high to low. In both cases, the frame rate is synchronized to the horizontal retrace signal 51.

The shutter control signal should be asserted at the same time in each image frame. The two examples represented by traces 53 and 55 show the shutter control signal being asserted either on the falling edge of the horizontal retrace signal of the first row or on the falling edge of the horizontal retrace signal of the second row. With these examples, the captured image is the entire display screen. In other words, if the display screen contains a number, n, of rows that are written in each frame, the shutter size is n rows. Thus, in the example represented by trace 53 in which the shutter control signal is asserted on the falling edge of the horizontal trace signal for the first row, the shutter size is n rows. The shutter size should be fixed, i.e., constant, but it does not need to be large enough to cover the entire image displayed on the display screen. For example, assuming a display screen that contains 480 lines, the shutter control signal could be synchronized to assert on the falling edge of the tenth row and on the falling edge of the four hundredth row. Increasing the shutter size decreases the frame rate, so these factors should be taken into consideration when choosing the shutter size.

The result of synchronizing the shutter control signal with the horizontal retrace signal is that the image captured by the sensor 40 may contain a few black stripes, but these stripes will not be random. These stripes will occur at a known time, and therefore can be removed using known image processing techniques.

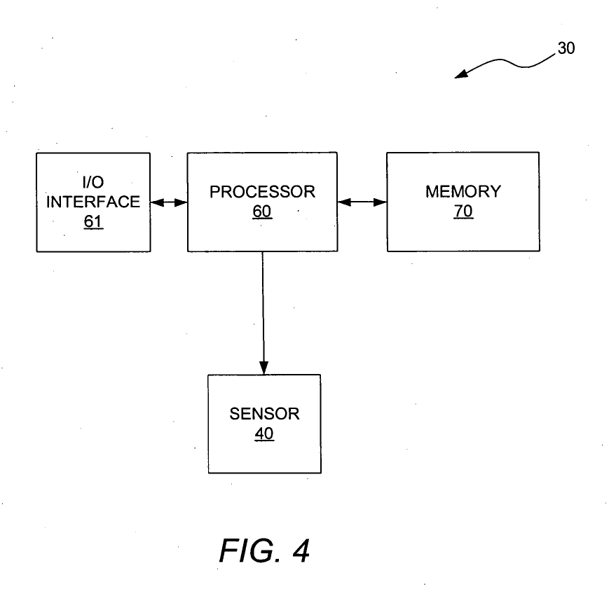

FIG. 4 illustrates a block diagram that represents the portion of the input device 30 that transforms the horizontal retrace signal into a shutter control signal. An input/output (I/O) interface 61 receives the horizontal retrace signal from the game console. This may be contained in the aforementioned composite video signal generated by the game console. A processor 60 receives the horizontal retrace signal and processes it to generate the shutter control signal, which is then delivered to the sensor 40. A memory device 70 may store data and one or more software programs to be executed by the processor 60. The processor may be any computational device such as, for example, a microprocessor, a microcontroller, an application specific integrated circuit (ASIC), a field programmable gate array, a programmable logic array, a system on a chip (SOC), a combination of discrete elements, etc. The memory device 70 may be any type of computer-readable medium, including, for example, random access memory (RAM), read only memory (ROM), flash memory, etc. The tasks performed by the processor 60 may be performed in hardware, software, or a combination of hardware and software or firmware.

It should be noted that the invention has been described with reference to exemplary and preferred embodiments, and that the invention is not limited to these embodiments. For example, although the shutter control signals have been described as being asserted on the falling edges of the horizontal retrace signal, this is preferred but not a requirement of the invention. What is important is that the shutter control signal is in some way synchronized to the horizontal retrace signal, which results in the frame rate being synchronized to the horizontal retrace signal. Also, although the optical sensor has been described as being part of the input device, the optical sensor may be separate from, and in communication with, the input device. Those skilled in the art will understand that modifications may be made to the embodiments described herein and that all such modifications are within the scope of the invention.

What is claimed is:

1. An apparatus for eliminating or reducing flickering in a video gaming system, the apparatus comprising:
a game console, the game console generating a horizontal retrace signal;
an input device in communication with the game console, the input device receiving the horizontal retrace signal from the game console, the input device having an optical sensor device, wherein the optical sensor device commences capturing of an image of at least a portion of a display screen upon receiving an asserted shutter control signal, and wherein the shutter control signal is synchronized with the horizontal retrace signal such that a frame rate of the optical sensor device is synchronized to the horizontal retrace signal.

2. The apparatus of claim 1, wherein the optical sensor device has a shutter size that is constant from one frame to the next, the shutter size corresponding to a number of rows of the display screen that are captured by the sensor device when the shutter control signal is asserted.

3. The apparatus of claim 2, wherein the shutter control signal is asserted when it is at a logic one level.

4. The apparatus of claim 2, wherein the shutter control signal is asserted when it is at a logic zero level.

5. The apparatus of claim 2, wherein the shutter size is less than a total number of rows of the display screen.

6. The apparatus of claim 2, wherein the shutter size is equal to or greater than a total number of rows of the display screen.

7. A method for eliminating or reducing flickering in a video gaming system, the method comprising:
in a game console, generating a horizontal retrace signal;
in an input device in communication with the game console, receiving the horizontal retrace signal from the game console, the input device having an optical sensor device, wherein the optical sensor device commences capturing of an image of at least a portion of a display screen upon receiving an asserted shutter control signal; and
synchronizing the shutter control signal with the horizontal retrace signal.

8. The method of claim 7, wherein the optical sensor device has a shutter size that is constant from one frame to the next, the shutter size corresponding to a number of rows of the display screen that are captured by the sensor device when the shutter control signal is asserted.

9. The method of claim 7, wherein the shutter control signal is asserted when it is at a logic one level.

10. The method of claim 7, wherein the shutter control signal is asserted when it is at a logic zero level.

11. The method of claim 7, wherein the shutter size is less than a total number of rows of the display screen.

12. The method of claim 7, wherein the shutter size is equal to or greater than a total number of rows of the display screen.

13. A computer program for eliminating or reducing flickering in a video gaming system, the program being embodied on a computer-readable medium, the program comprising:
instructions for receiving a horizontal retrace signal from a game console in an input device;
instructions for synchronizing a shutter control signal with the horizontal retrace signal, the shutter control signal controlling when the optical sensor device commences capturing of an image of at least a portion of a display screen.
